(19) United States
(12) Patent Application Publication
(10) Pub. No.: US 2012/0153671 A1
(43) Pub. Date: Jun. 21, 2012

(54) TRACTION SLIP INDICATOR

(76) Inventors: Dennis D. Wetterich, Newark, IL (US); Rafal Myslak, Oswego, IL (US)

(21) Appl. No.: 12/972,866

(22) Filed: Dec. 20, 2010

(51) Int. Cl. B62D 33/06; B60Q 1/00

(52) U.S. Cl. 296/190.01; 340/438

(57) ABSTRACT

A method for indicating traction slip is disclosed. The method includes sensing traction slip of at least one driven traction device of a machine and selectively activating at least one indicator in a repeating pattern indicative of the sensed traction slip of the at least one driven traction device. The at least one indicator includes at least one of a visual indicator, an audible indicator, or a vibratory indicator.

### TECHNICAL FIELD

The present disclosure relates generally to traction slip, and, more particularly, to a traction slip indicator.

### BACKGROUND

Agricultural, industrial, mining, and earth-moving machines often operate in worksites with poor traction caused by, for example, relatively poor terrain and/or relatively poor operating conditions. In many instances, poor traction causes the driven wheels of a machine to slip relative to the ground. Efficient operation of the machine often requires an operator to apply maximum power to drive the machine during hauling or loading operations, while avoiding wheel slip. Wheel slip is typically a result of an operator applying too much power or speed to the wheels relative to the traction conditions of the worksite. Wheel slip is an inefficient operation of the machine that can waste power and damage components of the machine, such as the tires of the driven wheels, unnecessarily adding cost to the operation of the machine. For example, the cost of replacing a tire, both in actual replacement cost and machine down time, can be quite substantial.

Maximizing power and speed, while avoiding wheel slip can be difficult and is often achieved based on operator experience and skill. Additionally, an operator may not have a direct line of sight to the wheels and thus may not be able to see the wheels slipping. For example tractors and other earth moving machines often have large fenders to protect an operator and other components of the machine from debris. In addition, an operator's line of sight is usually directed to a work tool on the machine during a loading and/or hauling operation.

One method for indicating wheel slip to an operator is disclosed in UK Patent Application GB 2 101 324 to Steel (“the '324 application”). The '324 application discloses a wheel slip indicator that provides a visual indication of the relative traction of one ground engaging member relative to the remaining ground engaging members. The wheel slip indicator compares the relative speed of the ground engaging members via a plurality of speed transducers so that traction of any one ground engaging member can be compared with the traction of the other ground engaging members. The wheel slip indicator also includes a display that shows the relative magnitude of the speed of each of the ground engaging members, as well as the percentage differential of wheel slip between the left-side and right-side ground engaging members via respectively illuminated indicator columns. If there is a loss of traction of any of the ground engaging members, the relative magnitude of the speed of the slipping ground engaging member will be different relative to the non-slipping ground engaging members.

Although the method of the '324 application may visually show which one of a plurality of ground engaging members is slipping, it may not do so within an operator's peripheral line of sight. As such, an operator may need to look away from an operating task, e.g., operating a work tool or driving the machine, to see the display of the wheel slip indicator of the '324 application. Additionally, the wheel slip indicator of the '324 application may not display a repeating pattern that is indicative of the amount or direction of wheel slip of a given ground engaging member.

The present disclosure is directed to overcoming one or more of the shortcomings set forth above.

### SUMMARY

In one aspect, the present disclosure is directed to a method for indicating traction slip. The method includes sensing traction slip of at least one driven traction device of a machine and selectively activating at least one indicator in a repeating pattern. The repeating pattern is indicative of the sensed traction slip of the at least one driven traction device. The at least one indicator is a visual indicator, an audible indicator, or a vibratory indicator.

In another aspect, the present disclosure is directed to a machine. The machine includes a first traction device engaging a surface that is configured to selectively propel the machine relative to the surface. The machine also includes an operator cab including a frame that at least partially surrounds the operator cab. The frame defines at least one operator sight path through the frame and at least partially defines a periphery of the at least one operator sight path. The machine also includes a first set of indicator lights disposed on the frame at the periphery of the at least one operator sight path. The machine further includes a controller configured to determine slip between the first traction device and the surface. The controller selectively illuminates the first set of indicator lights in a repeating pattern indicative of the determined slip between the first traction device and the surface.

### BRIEF DESCRIPTION OF THE DRAWINGS

FIG. 1 is a diagrammatic illustration of an exemplary disclosed machine;

FIG. 2 is a diagrammatic illustration of a portion of the exemplary machine of FIG. 1; and

FIG. 3 is a block diagram of an exemplary control system for use with the exemplary machine of FIG. 1.

### DETAILED DESCRIPTION

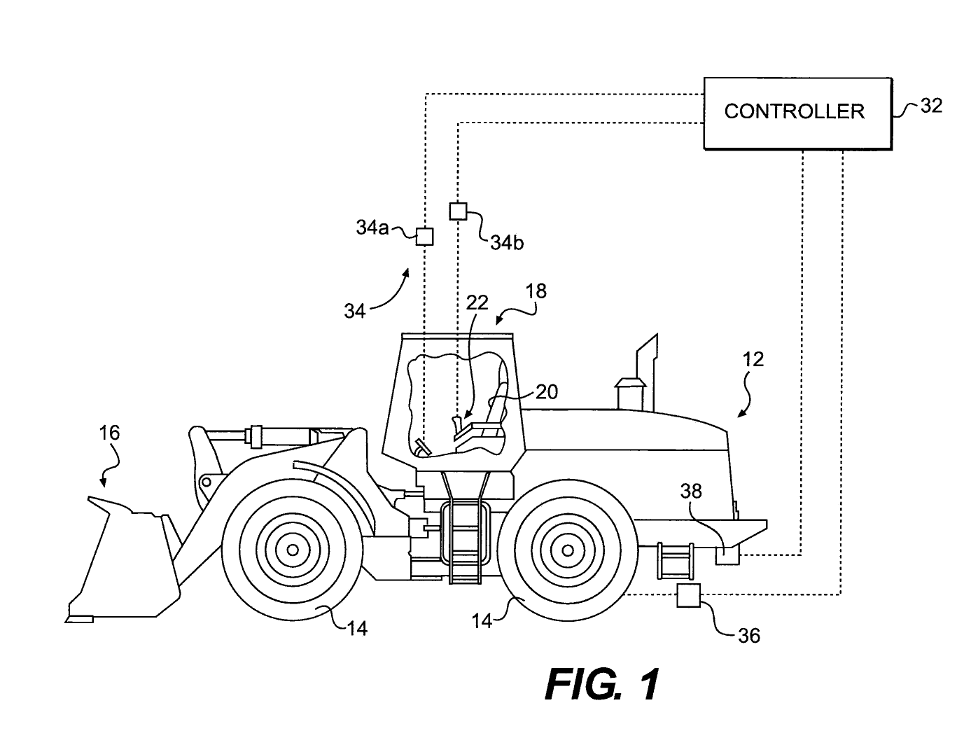

FIG. 1 illustrates an exemplary machine 12 configured to operate in a worksite. Machine 12 may include any mobile machine that performs some type of operation associated with an industry, such as, for example, mining, construction, farming, or any other industry known in the art. For example, machine 12 may be an earth-moving machine such as a dozer, a loader, a backhoe, an excavator, a motor grader, or any other earth-moving machine. Machine 12 may be configured to traverse the work site to manipulate material, e.g., transport, cultivate, dig, agitate, and/or perform any other operation known in the art. Machine 12 may include one or more wheels 14, at least one implement 16, a cab 18 including a seat 20 and one or more operator controls 22, and a controller 32. It is contemplated that machine 12 may additionally include a power source (not shown) configured to produce mechanical power and/or any other component known in the art. It is also contemplated that implement 16 may include any device to perform a task relative to the worksite such as, for example, a blade, a bucket, a shovel, a ripper, and/or any other task-performing device known in the art. It is further contemplated that the worksite may include any type of terrain including, for example, dirt, aggregate, sand, other terrains know in the art, and/or combinations thereof.

Wheels 14 may be configured to engage a surface of the worksite in which machine 12 operates. Although generally described as including wheels, it is contemplated that machine 12 may include tracks or any other ground engaging traction device known in the art. Machine 12 may also be configured to selectively supply power to drive one or more of wheels 14 to propel and drive machine 12 around the worksite. It is contemplated that machine 12 may include any number of wheels 14 and may be configured to selectively supply power to any number of wheels 14. As such, one or more of wheels 14 may be driven wheels and one or more of wheels 14 may non-driven wheels.

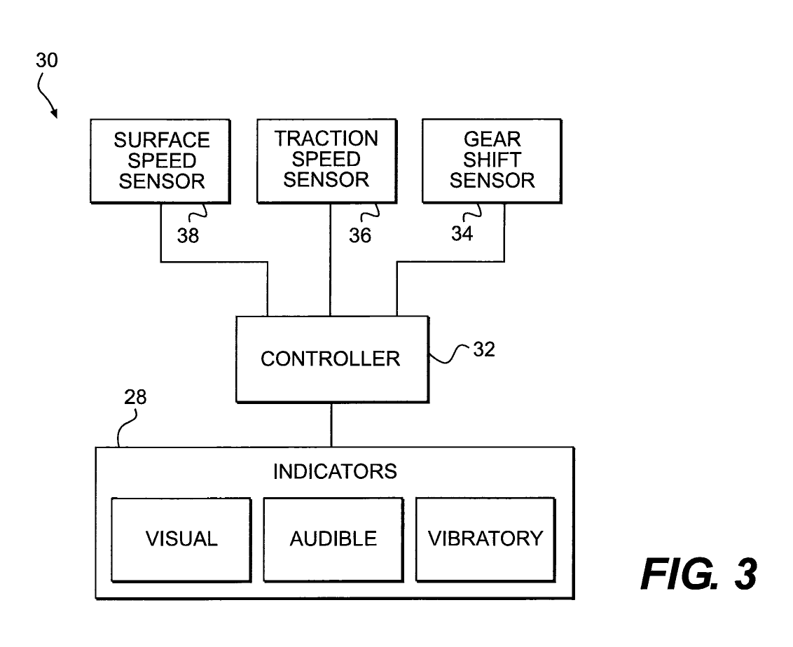

Machine 12 may further include one or more sensors respectively configured to establish a signal as a function of a sensed physical parameter. For example, a gear shift sensor 34 may be configured to sense a position of one or more operator control devices 22, a traction speed sensor 36 may be configured to sense the speed of wheels 14 with respect to machine 12, and a surface speed sensor 38 may be configured to sense the speed of machine 12 with respect to a surface of the worksite. It is contemplated that gear shift sensor 34 may include a plurality of sensors, such as, for example sensors 34a, 34b respectively configured to sense a position of one of operator control devices 22, e.g., a pedal (not referenced) and a gear shifter (not referenced). It is contemplated that sensors 34, 36, 38 may embody any conventional type of sensor known in the art. The function of sensors 34, 36, 38 is further described below in conjunction with the description of controller 32 with reference to FIG. 3.

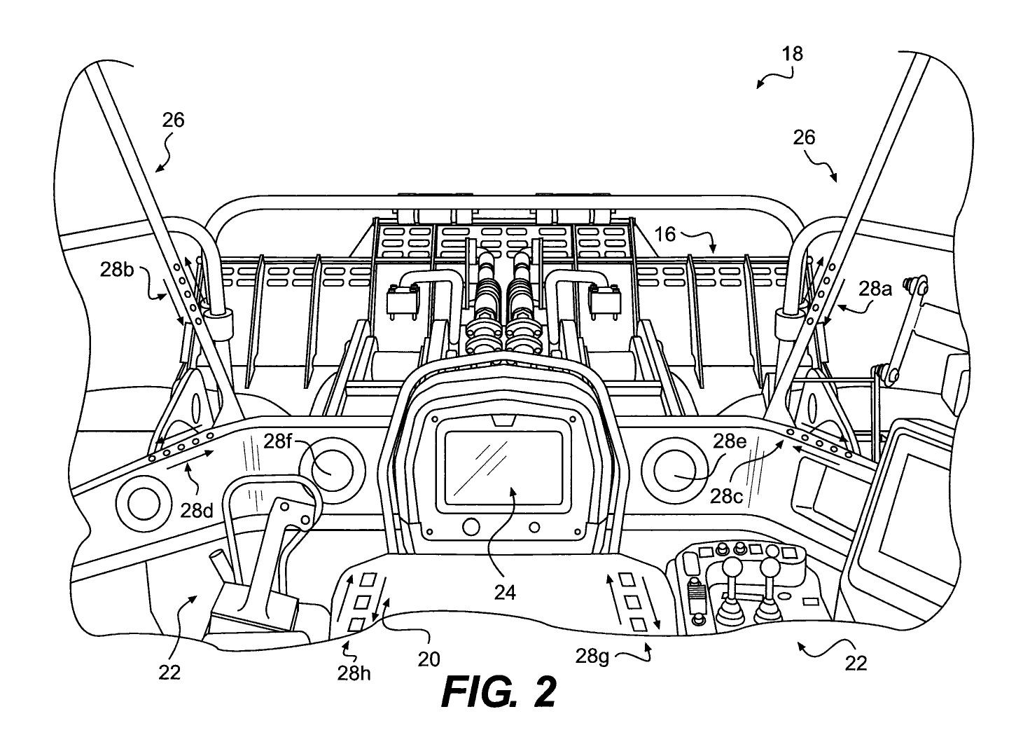

As shown in FIG. 2, cab 18 may include an operator seat 20 configured to support an operator within cab 18. Seat 20 may include a seat portion, a back portion, and armrests configured to support various portions of an operator (see FIG. 1). Cab 18 may also include operator controls 22, such as joysticks, control levers, pedals, or other operator control devices known in the art. Controls 22 may be configured to selectively control and operate the power source, wheels 14, implement 16, or other operations of machine 12. Controls 22 may include a throttle configured to selectively supply power to control the speed of machine 12, a gear shift configured to selectively select a drive direction of machine 12, and/or a steering device configured to selectively orient wheels 14 and steer machine 12 relative to the surface of the worksite. Cab 18 may also include an operator display 24, e.g., a dash panel, configured to display information to the operator regarding the operation of machine 12. For example, operator display 24 may embody an LCD, CRT, LED, or other type of display device and may include a speedometer, a tachometer, a fuel gauge, temperature gauge, and/or any other gauge or display known in the art to provide an indication of the operation of machine 12 and the various operating components of machine 12.

Cab 18 may further include a frame 26 surrounding an operator and generally defining the contours of cab 18. Frame 26 may include one or more windows defining one or more operator sight paths from inside cab 18 to the remainder of machine 12 and to the worksite. The one or more windows may be separated by one or more frame members and may be closed windows, i.e., windows having glass or other transparent material enclosing the interior of cab 18, or may be open windows, i.e., windows without glass or other transparent material. As such, an operator may have one or more sight paths through the windows and frame 26 to see implement 16 so that the operator may manipulate and perform tasks with implement 16 and/or to see the worksite so that the operator may steer and propel machine 12. It is contemplated that the operator may be able to directly see various portions of machine 12, but may not be able to directly see the wheels 14 from within cab 18 because wheels 14 may be, for example, blocked by fenders (not shown) and/or other components of machine 12. It is also contemplated that wheels 14 may be arranged relative to a given one of the operator sight paths through frame 26. For example, a first wheel may be disposed on a first side of machine 12 on a first side of a given operator sight path and a second wheel may be disposed on a second side of machine 12 on a second side of a given operator sight path.

One or more traction slip indicators 28 may be disposed within cab 18. Indicators 28 may include visual indicators, audible indicators, and/or vibratory indicators configured to be selectively activated to indicate an amount or type of traction slip. As described in more detail below, indicators 28 may be selectively activated by controller 32 to produce a repeating pattern indicative of the sensed traction slip that machine 12, and in particular wheels 14, may be experiencing. For example, as discussed in more detail below, the repeating pattern may visually, audibly, and/or vibrationally communicate the amount and/or direction of the traction slip that wheels 14 may be experiencing. It is contemplated that indicator 28 may be disposed within cab 18 such that given ones of indicators 28 are disposed on a first side of a given operator sight path and other ones of indicators 28 are disposed on a second side of the given operator sight path. Such indicators may respectively correspond with the wheels that are similarly disposed on first and second sides of the given operator sight path.

The visual indicators may include, for example, multiple sets of indicator lights 28a, 28b, 28c, 28d disposed on frame 26 at a periphery of one or more operator sight paths through a window. Each set of indicator lights 28a, 28b, 28c, 28d may include a plurality of individual lights arranged in a series. As shown in FIG. 2, each set of indicator lights may include five lights, however, it is contemplated that each set may include any number of lights. The individual lights may include any type of conventional lights, e.g., LEDs, diodes, or incandescent lights, and may be any size and/or any color.

The audible indicators may include, for example, a plurality of speakers 28e, 28f disposed on frame 26 and configured to produce and broadcast an audible alarm or other sound that can be heard by an operator. It is contemplated that the audible indicators may include any conventional speaker, may be any size, and may be configured to produce any type of sound.

The vibratory indicators may include, for example, one or more sets of vibration modules 28g, 28h disposed on or within seat 20. Each set of vibration modules may include a plurality of vibration elements arranged in series and may, for example, be disposed in the seat portion (as shown in FIG. 2), the back portion (not shown), and/or the armrests (not shown) of seat 20. Similar to each set of indicator lights, each set of vibration modules may include any number of vibration elements arranged in a series. It is contemplated that the vibration elements may include any conventional vibration device and may be any size.

FIG. 3 illustrates a control system 30 that may be integrated with machine 12 and configured to control one or more operations of machine 12, such as movement of machine 12 about the worksite and/or operation of implement 16. In particular, control system 30 may be configured to sense and indicate traction slip of one or more of wheels 14 relative to a surface of the worksite. Control system 30 includes controller 32, gear shift sensor 34, traction speed sensor 36, and surface speed sensor 38. Controller 32 may be connected to indicators 28 to selectively activate indicators 28 to selectively produce a repeating pattern as a function of the sensed traction slip.

Controller 32 may embody a computer having a single microprocessor or multiple microprocessors. Numerous commercially available microprocessors may be configured to perform the functions of controller 32. Controller 32 may readily embody a general machine microprocessor capable of controlling numerous machine functions. Various circuits may be associated with controller 32, such as power supply circuitry, signal conditioning circuitry, data acquisition circuitry, signal output circuitry, signal amplification circuitry, and other types of circuitry known in the art. In particular, controller 32 may include one or more algorithms, decision logic sequences, and/or other programming capabilities to monitor and determine traction device slip relative to a surface of the worksite, as will be described in more detail below.

Gear shifter sensor 34 may embody a position sensor configured to determine and generate an output indicative of the selected drive operation of machine 12. For example, gear shifter sensor 34 may include one or more sensors 34a, 34b configured to monitor one or more of operator controls 22, e.g., a pedal or a lever, and generate one or more signals indicative of the drive direction of machine 12 as selected by an operator. It is contemplated that gear shift sensor 34 may monitor a pedal, joystick, hand lever, or other type of gear shift mechanism configured to selectively control machine 12 in forward or reverse directions. As shown in FIG. 1, sensor 34a is configured to monitor a position of a pedal (not referenced) and sensor 34b is configured to monitor a position of a lever.

Traction device sensor 36 may embody a velocity sensor configured to determine and generate an output indicative of the driven speed of one or more of wheels 14. For example, traction speed sensor 36 may be disposed adjacent a driven component, e.g., a sprocket (not referenced), axle (not referenced), or a transmission drive shaft (not referenced), or any other component of machine 12 configured to apply a drive force, e.g., a torque, to one or more wheels 14. Traction device sensor 36 may be configured generate one or more signals indicative of the speed of the driven wheels of machine 12 as selected by an operator. Such a speed is generally referred to as “driven speed.” It is contemplated that traction device sensor 36 may include multiple velocity sensors respectively configured to determine the driven speed of each of wheels 14.

Surface speed sensor 38 may embody a radar sensor configured to determine and generate an output indicative of the speed of machine 12 relative to a surface of the worksite on which machine 12 is propelled. For example, surface speed sensor 38 may be configured to send and receive electromagnetic waves to and from the surface on which machine 12 is propelled and generate one or more signals indicative of the actual speed that machine 12 is driven relative to the surface. Such a speed is generally referred to as “ground speed” and may not be the same as the driven speed of wheels 14. That is, one or more of wheels 14 may be driven at a first speed, as desired by the operator, and machine 12 may be propelled relative to the surface at a second speed, less than the first, such that the driven wheels 14 slip relative to the surface.

This difference between the driven speed and the ground speed may be due to the terrain and worksite conditions. Traction slip may be a result of the operator supplying too much power to one of more of wheels 14 and/or resistance caused by implement 16 engaging material on the worksite. For example, implement 16 may apply a force on machine 12 as a function of the friction between implement 16 and material in the worksite thus resisting movement of machine 12 as propelled by wheels 14. Controller 32 may determine the traction slip by comparing the driven speed of one or more of wheels 14 as sensed by traction speed sensor 36 with the ground speed of machine 12 as sensed by surface speed sensor 38. In addition, controller 32 may determine the direction of slip, e.g., forward or reverse, as sensed by gear shift sensor 34. It is contemplated that controller 32 may determine traction slip by any method or manner known in the art.

Controller 32 may be connected to indicators 28 and may be configured to selectively activate one or more of the visual indicators, the audible indicators, or the vibratory indicators in a pattern indicative of the sensed traction slip. For example, controller 32 may selectively send output signals to one or more of the individual lights to selectively illuminate one or more of multiple sets of indicator lights 28a, 28b, 28c, 28d in respective repeating patterns. Controller 32 may selectively send output signals to one or more of the speakers of audible indicators 28 e, 28f to selectively broadcast sounds, e.g., a series of beeps or tones, in respective repeating patterns. Controller 32 may selectively send output signals to one or more of the vibration elements mounted in seat 20 to selectively vibrate the multiple sets of vibration modules 28g, 28h in respective repeating patterns.

It is contemplated that one or more of wheels 14 may be driven and that one driven wheel may experience slip at substantially the same time as another driven wheel is experiencing slip, wherein the respective slip is different. As such, controller 32 may be configured to respectively activate some of indicators 28 in a first pattern indicative of the traction slip sensed for one of the slipping wheels and selectively activate another of the indicators 28 in a second pattern indicative of the traction slip sensed for the other one of the indicators 28, the second pattern being different from the first pattern.

The repeating pattern of indicators 28 may be indicative of the amount of the sensed traction slip. For example, for a relatively low amount of slip, the repeating pattern, e.g., the selectively illuminated lights, selectively broadcast sounds, and/or the selectively vibrated elements, may be relatively slow as compared to when a relatively high amount slip is sensed. That is, the repeating pattern may be repeated at a relatively faster frequency for relatively higher sensed traction slip. It is contemplated that the pattern may be more or less intense, i.e., brighter or dimmer illumination, louder or quieter broadcast sounds, and/or more or less vibration, to indicate a relatively greater or smaller amounts of traction slip.

In addition, the number of lights, number of broadcast sounds, and/or the number of vibration elements that are selectively activated may be varied to indicate the amount of sensed traction slip. For example, for a relatively low amount of sensed slip, less than all of the lights or vibration modules, and a fewer number of broadcast sounds may be activated and repeated in the pattern as compared to when a relatively high amount of traction slip is sensed. It is also contemplated that, as shown with directional arrows in FIG. 2, the lights and/or the vibration elements may be selectively activated in sequence in a first direction indicative of a forward slip, and selectively activated in a sequence in a second direction, opposite the first direction indicative of reverse slip. It is further contemplated that the repeating pattern for any of indicators 28 may be adjusted and/or varied in intensity, direction, frequency, number, and/or in any other way to indicate the type and/or amount of traction slip.

### INDUSTRIAL APPLICABILITY

The traction slip indicator may be applicable to any driven machine. The disclosed method and apparatus may more readily indicate traction slip to an operator via one or more visual, audible, and/or vibratory indicators. In addition, the disclosed system may indicate the type and amount of slip by selectively activating one or more indicators in a pattern indicative of the slip. Because the visual indicators may be disposed at the periphery of an operators line of sight, the operator may recognize slip is occurring without significantly diverting attention from operating a work tool or driving the machine. Moreover, the use of audible and/or vibratory indicators may also notify an operator of traction slip without diverting the operator's line of sight.

It will be apparent to those skilled in the art that various modifications and variations can be made to the disclosed traction slip indicator. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A method for indicating traction slip, comprising:
sensing traction slip of at least one driven traction device of a machine;
selectively activating at least one indicator in a repeating pattern indicative of the sensed traction slip of the at least one driven traction device;
wherein the at least one indicator includes at least one of a visual indicator, an audible indicator, or a vibratory indicator.

2. The method of claim 1, wherein the at least one indicator is a visual indicator including a set of indicator lights arranged in series and selectively activating the at least one indicator includes selectively activating the set of indicator lights to selectively illuminate in the repeating pattern.

3. The method of claim 1, wherein the at least one indicator is an audible indicator including at least one speaker and selectively activating the at least one indicator includes selectively activating the at least one speaker to selectively broadcast at least one sound in the repeating pattern.

4. The method of claim 1, wherein the at least one indicator is a vibratory indicator including a set of vibration elements in series and selectively activating the at least one indicator includes selectively activating the set of vibration elements to selectively vibrate in the repeating pattern.

5. The method of claim 1, wherein the at least one driven traction device is one of a plurality of driven wheels of the machine and the indicator includes a plurality of sets of indicator lights, each set of indicator lights respectively associated with one of the plurality of driven wheels, the method further includes:
sensing traction slip of a first and a second driven wheel, the first and second driven wheels slipping at substantially the same time;
selectively illuminating a first set of indicator lights in first repeating pattern indicative of the sensed slip of the first driven wheel; and
selectively illuminating a second set of indicator lights in a second repeating patter indicative of the sensed slip of the second driven wheel.

6. The method of claim 5, wherein the machine includes an operator cab having a frame at least partially surrounding the operator cab and defining at least one operator sight path through the frame, the frame at least partially defining a periphery of the at least one operator sight path and each set of indicator lights is disposed on the frame at the periphery of the at least one operator sight path.

7. The method of claim 5, wherein:
the machine includes an operator cab having a frame at least partially surrounding the operator cab and defining at least one operator sight path through the frame and a dash panel configured to selectively indicate operating parameters of the machine; and
each set of indicator lights is disposed on the frame at a periphery of the at least one operator sight path remote from the dash panel.

8. The method of claim 5, further including:
sequentially illuminating the first set of indicator lights in a first direction when the first driven wheels is driven in a forward direction and is slipping; and
sequentially illuminating the first set of indicator lights in a second direction, opposite the first direction, when the first driven wheel is driven in a reverse direction and is slipping.

9. The method of claim 5, further including:
sequentially illuminating the first set of indicator lights at a first frequency when the first driven wheel is slipping at a first amount; and
sequentially illuminating the first set of indicator lights at a second frequency, different than the first frequency, when the first driven wheel is slipping at a second amount different than the first amount.

10. A method for indicating slip to an operator of a machine, comprising:
sensing slip of a first and second driven traction devices of a machine;
selectively illuminating a first set of indicator lights in a first repeating pattern indicative of the sensed slip of the first driven traction device;
selectively illuminating a second set of indicator lights in a second repeating pattern indicative of the sensed slip of the second driven traction device, the second repeating pattern being different from the first repeating pattern;
wherein the machine includes an operator cab having a frame at least partially surrounding the operator cab and defining at least one operator sight path through the frame, the frame at least partially defining a periphery of the at least one operator sight path; and
wherein the first and second sets of indicator lights are disposed on the frame at the periphery of the at least one operator sight path.

11. The method of claim 10, wherein:
the first traction device is disposed on the machine on a first side of the at least one operator sight path and the second traction device is disposed on the machine on a second side of the at least one operator sight path, substantially opposite the first side;
the frame defines first and second sides of the periphery of the at least one operator sight path, the first side of the periphery disposed on the same side of the machine as the first traction device and the second side of the periphery disposed on the same side of the machine as the second traction device; and
the first set of indicator lights disposed on the frame on the first side of the periphery and the second set of indicator lights disposed on the frame on the second side of the periphery.

12. The method of claim 11, wherein machine further includes a work tool disposed on the machine between the first and second sides of the at least one operator sight path.

13. The method of claim 10, further including:
sequentially illuminating the first set of indicator lights in a first direction when the first driven traction device is driven in a forward direction and is slipping; and
sequentially illuminating the first set of indicator lights in a second direction, opposite the first direction, when the first traction device is driven in a reverse direction and is slipping.

14. The method of claim 10, further including:
sequentially illuminating the first set of indicator lights at a first frequency when the first driven traction device is slipping at a first amount; and
sequentially illuminating the first set of indicator lights at a second frequency, different than the first frequency, when the first driven traction device is slipping at a second amount different than the first amount.

15. A machine comprising;
a first traction device engaging a surface and configured to selectively propel the machine relative to the surface;
an operator cab including a frame at least partially surrounding the operator cab and defining at least one operator sight path through the frame, the frame at least partially defining a periphery of the at least one operator sight path;
a first set of indicator lights disposed on the frame at the periphery of the at least one operator sight path; and
a controller configured to determine slip between the first traction device and the surface and selectively illuminate the first set of indicator lights in a repeating pattern indicative of the amount or direction of the determined slip between the first traction device and the surface.

16. The machine of claim 15, further including:
a second traction device engaging the surface and configured to selectively propel the machine relative to the surface; and
a second set of indicator lights disposed on the frame at the periphery of the at least one operator sight path;
wherein the controller is further configured determine slip between the second traction device and the surface and selectively illuminate the second set of indicator lights in a repeating pattern indicative of the determined slip between the second traction device and the surface.

17. The machine of claim 16, wherein:
the first traction device is disposed on the machine on a first side of the at least one operator sight path and the second traction device is disposed on the machine on a second side of the at least one operator sight path, substantially opposite the first side;
the frame defines first and second sides of the periphery of the at least one operator sight path, the first side of the periphery disposed on the same side of the machine as the first traction device and the second side of the periphery disposed on the same side of the machine as the second traction device; and
the first set of indicator lights is disposed on the frame on the first side of the periphery and the second set of indicator lights is disposed on the frame on the second side of the periphery.

18. The machine of claim 17, further including a work tool, wherein the work tool is disposed on the machine between the first and second sides of the at least one operator sight path.

19. The machine of claim 15, wherein the controller is further configured to:
sequentially illuminate the first set of indicator lights in a first direction when the first driven traction device is driven in a forward direction and is slipping; and
sequentially illuminate the first set of indicator lights in a second direction, opposite the first direction, when the first traction device is driven in a reverse direction and is slipping.

20. The method of claim 15, wherein the controller is further configured to sequentially illuminate the first set of indicator lights at a first frequency when the first driven traction device is slipping at a first amount and sequentially illuminate the first set of indicator lights at a second frequency, different than the first frequency, when the first driven traction device is slipping at a second amount different than the first amount.
